(19) United States
(12) Patent Application Publication
(10) Pub. No.: US 2025/0110211 A1
(43) Pub. Date: Apr. 3, 2025

(54) STATE OR ACTIVITY DETECTION

(71) Applicant: Essence SmartCare Ltd., Herzlia Pituach (IL)

(72) Inventors: Ilan HEVDELI, Ganei-Tikva (IL); Lawrence Berman, Beit Shemesh (IL); Benyamin Finkelstein, Yavne (IL)

(21) Appl. No.: 18/397,911

(22) PCT Filed: Aug. 24, 2022
(86) PCT No.: PCT/IL2022/050926

§ 371 Date: Dec. 27, 2023

(30) Foreign Application Priority Data
Aug. 26, 2021 (GB) 2112225.4

(51) Int. Cl. G01S 7/41

(52) U.S. Cl. CPC G01S 7/415

(57) ABSTRACT

Embodiments relate to a device, method and system for determining a state or an activity of a person in an environment. The method comprises: obtaining a classification of a region within a building that is monitored by an active reflected wave detector; configuring a classifier based on the classification; controlling the active reflected wave detector to measure wave reflections from the region within the building to receive measured wave reflection data that is obtained by the active reflected wave detector; and using the classifier, after said configuring, to determine the state or the activity of the person using the measured wave reflection data.

### RELATED APPLICATION

This application claims the benefit of priority of Great Britain Patent Application No. 2112225.4 filed on 26 Aug. 2021, the contents of which are incorporated herein by reference in their entirety.

### TECHNICAL FIELD

The present invention relates generally to a device, method and system for determining a state or an activity of a person in an environment. Some embodiments relate more specifically to fall detection.

### BACKGROUND

There is a need to use a monitoring system to automatically detect and identify a state or activity of a person. One example is when a person has fallen in a designated space, for example in an interior of a building. For example, an elderly person may end up in a hazardous situation when they have fallen and are unable to call for help, or unable to do so quickly.

Some known systems have been developed in which the person wears a pendant which has an accelerometer in it to detect a fall based on kinematics. The pendant upon detecting a fall can transmit an alert signal. However the person may not want to wear, or may be in any case not wearing, the pendant.

Other systems are also known to monitor a person in a space. For example a radar may be used to determine an activity of a state of a person.

### SUMMARY

The inventors have identified that known techniques for determining a state or an activity of a person using an active reflected wave detector (e.g. radar, or sonar or lidar) can suffer from poor detection accuracy.

Classification accuracy is of particular importance. For example, when determining a state of a person, determining that a person is in a non-fall state when they are in fact in a fall state will result in an alert not being raised, leaving the person in a hazardous situation. Determining that a person is in a fall state when they are in fact in a non-fall state will result in power being unnecessarily consumed in the generation and transmission of an alert, and may result in unnecessary emergency responses.

Classification accuracy may be improved by using complex classification models, but such models require significant memory to be stored. Techniques requiring a large amount of memory resource may be problematic for devices for which it is desirable that the device is housed in a compact housing, has low cost of goods and/or has memory resources are limitations for any other reason.

According to one aspect of the present disclosure there is provided a computer implemented method for determining a state or an activity of a person, the method comprising:
obtaining a classification of a region within a building that is monitored by an active reflected wave detector, configuring a classifier based on the classification;
controlling the active reflected wave detector to measure wave reflections from the region within the building to receive measured wave reflection data that is obtained by the active reflected wave detector; and
using the classifier, after said configuring, to determine the state or the activity of the person using the measured wave reflection data.

In embodiments of the present disclosure, classification detection accuracy may be increased by the classification being performed using the classifier that has been configured based on the classification of a region within a building that is monitored by the active reflected wave detector. That is, it has been found by the present inventors that the accuracy of a state or activity classifier may be improved by having that classifier optimized for a specific indoor environment in which it is to be operated. This may be a result of different kinds of indoor environments resulting in characteristically different indirect wave reflections. The optimization may be achieved by training the classifier using training data collected from one or more comparable environments, e.g. from one or more rooms of the same kind (i.e. classification) to which the state or activity classifier is to operate in use.

The region that is monitored by the active reflected wave detector may be, or be within, an enclosed space of the building. The enclosed space may be a room of the building. The region that is monitored by the active reflected wave detector may be, or be within, a circulation space of the building.

The classification of the region may comprise a size classification of the region.

The classification of the region may comprise a functional design classification of the region.

The classification of the region may comprise a geometric classification of the region.

A plurality of trained classifier models may be accessible to the classifier, the configuring the classifier may comprise selecting a trained classifier model of the plurality of trained classifier models, and the selected trained classifier model may be used to determine the state or activity of the person.

The method may further comprise: determining one or more parameters associated with the measured wave reflection data; and supplying the determined parameters as inputs into the selected trained classifier model to determine the state or activity of the person.

In some embodiments, the determined parameters comprise features extracted from the measured wave reflection data and do not comprise the wave reflection data itself.

The plurality of trained classifier models comprise trained classifier models associated with different classifications of regions of a building.

Each of the plurality of trained classifier models may be trained with training data obtained using one or more regions of a building corresponding to the respective classification of the different classifications of regions of a building.

Thus the selected classifier model is trained with training data that relates to people in positions in the particular type of region. For example, consider a scenario where the device is positioned in a bedroom, the selected classifier model may be trained with wave reflection data training sets each associated with a person in a bedroom.

The classifier models may be stored on non-transient memory of a device, the device comprising the active reflected wave detector. Storage of each classifier model may respectively consume no more than 500 kilobytes of memory.

Each classifier model may be a decision tree or a support vector machine (SVM) model.

In an alternative embodiment each classifier model may be a deep learning model. The deep learning model may comprise a neural network having, an input, and output and therebetween 3 or more layers, but preferably no more than 5 layers, and more preferably no more than 4 layers between the input and output.

For example each classifier model may comprise an input and output and 4 condensed layers. Each condensed layer may consist of no more than 128 neurons, preferably no more than 64 neurons, more preferably no more than 32 neurons.

The classification may be selected from a group comprising: a living room; and a non living-room. In another embodiment the classification may be selected from a group comprising: a living room; and a bedroom. In another embodiment, the classification may be selected from a group comprising: a living room; a bathroom and a third kind of region. The third kind of region may be defined as being neither a living room nor a bathroom, or may be a distinct kind of its own, e.g. a bedroom.

Each classification in the group may correspond to a respective room size, wherein the living room classification corresponds to a room size that is greater than a room size corresponding to the non living-room classification.

Controlling the active reflected wave detector to measure wave reflections from the environment may be performed in response to detecting motion in the environment based on receiving motion detection data from a motion detector. Controlling the active reflected wave detector to measure wave reflections from the environment may be performed upon expiry of a time window that commences in response to the motion sensor detecting motion of a person.

According to another aspect of the present disclosure there is provided at least one computer-readable storage medium comprising instructions which, when executed by at least one processor cause the at least one processor to perform the method steps of one or more embodiments described herein.

The instructions may be provided on one or more carriers. For example there may be one or more non-transient memories, e.g. a EEPROM (e.g. a flash memory) a disk, CD- or DVD-ROM, programmed memory such as read-only memory (e.g. for Firmware), one or more transient memories (e.g. RAM), and/or a data carrier(s) such as an optical or electrical signal carrier. The memory/memories may be integrated into a corresponding processing chip and/or separate to the chip. Code (and/or data) to implement embodiments of the present disclosure may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language.

According to another aspect of the present disclosure there is provided a device for determining a state or an activity of a person, the device comprising:
a processor, wherein the processor is configured to:
obtain a classification of a region within a building that is monitored by an active reflected wave detector;
configure a classifier based on the classification;
control the active reflected wave detector to measure wave reflections from the region within the building to receive measured wave reflection data that is obtained by the active reflected wave detector; and
use the configured classifier, to determine the state or the activity of the person using the measured wave reflection data.

The processor may be configured to perform any of the method steps described herein.

The device may further comprise the active reflected wave detector.

The active reflected wave detector may be a radar sensor or a sonar sensor.

According to another aspect of the present disclosure there is provided a system for determining a state or an activity of a person, the system comprising:
a processing system configured to perform the following steps:
obtain a classification of a region within a building that is monitored by an active reflected wave detector;
configure a classifier based on the classification;
control the active reflected wave detector to measure wave reflections from the region within the building to receive measured wave reflection data that is obtained by the active reflected wave detector; and
use the configured classifier, to determine the state or the activity of the person using the measured wave reflection data.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE SEVERAL VIEWS OF THE DRAWINGS

For a better understanding of the present disclosure and to show how embodiments may be put into effect, reference is made to the accompanying drawings in which:

FIG. 1 illustrates an environment in which a device has been positioned;

FIG. 2 is a schematic block diagram of the device;

FIGS. 3a and 3b illustrates a human body with indications of reflections measured by a reflective wave detector when the person is in a standing non-fall state and in a fall state;

FIG. 4a is a further schematic block diagram of the device;

FIG. 4b illustrates a memory of the device storing two models associated with different functional design classifications of regions of a building;

FIG. 4c illustrates a memory of the device storing models associated with different size classifications of regions of a building;

FIG. 4d illustrates a memory of the device storing models associated with different functional design classifications of regions of a building;

FIG. 4e illustrates a memory of the device storing models associated with different size classifications of regions of a building having the same functional design;

FIG. 4f illustrates a memory of the device storing models associated with different geometric classifications of regions of a building; and

FIG. 5 illustrates a process for determining a state of a person in accordance with embodiments of the present disclosure.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized, and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents. In the following embodiments, like components are labelled with like reference numerals. In the following embodiments, the term data store or memory is intended to encompass any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., EEPROM, solid state drives, random-access memory (RAM), etc.), and/or the like. Further, a data store or memory may be comprised of a single medium/device or a plurality of mediums/devices, optionally comprising a plurality of different mediums/devices.

As used herein, except wherein the context requires otherwise, the terms “comprises”, “includes”, “has” and grammatical variants of these terms, are not intended to be exhaustive. They are intended to allow for the possibility of further additives, components, integers or steps.

The functions or algorithms described herein are implemented in hardware, software or a combination of software and hardware in one or more embodiments. The software comprises computer executable instructions stored on computer readable carrier media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor.

Specific embodiments will now be described with reference to the drawings.

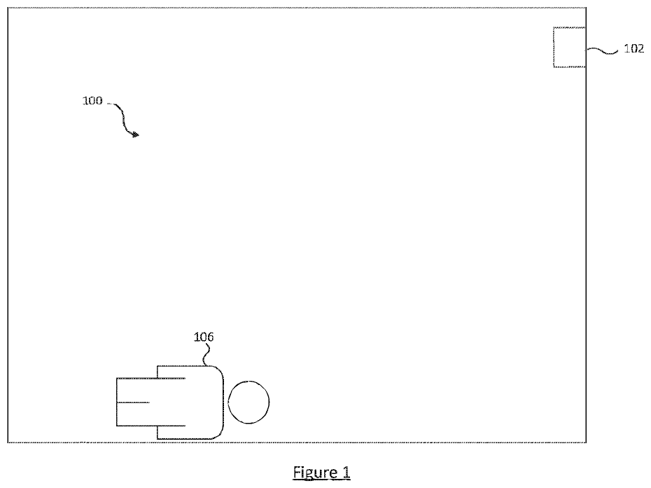

FIG. 1 illustrates an environment 100 in which a device 102 has been mounted to a wall. It will be appreciated that the device may also be mounted to a ceiling or on a post away from the ceiling and walls. The environment 100 may for example be an indoor space such as a room of a home, a nursing home, a public building or other indoor space. The device 102 may be used to detect a person 106 having fallen (that is, being in a fall position) which is illustrated in FIG. 1.

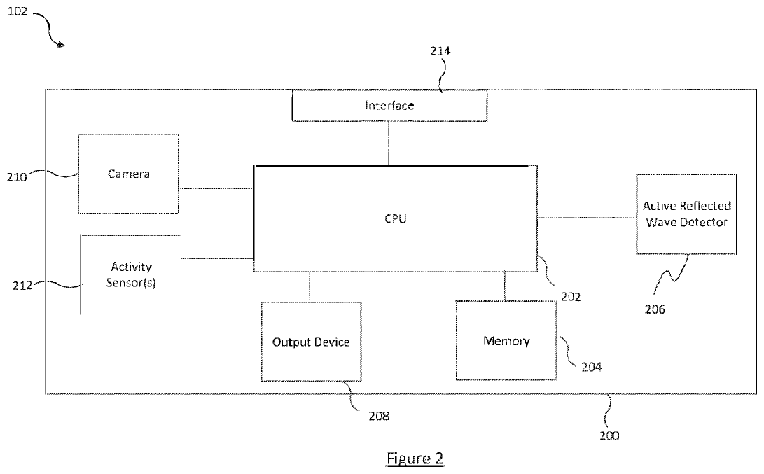

FIG. 2 illustrates a simplified view of the device 102. A shown in FIG. 2, the device 102 comprises a central processing unit (“CPU”) 202, to which is connected a memory 204. The functionality of the CPU 202 described herein may be implemented in code (software) stored on a memory (e.g. memory 204) comprising one or more storage media, and arranged for execution on a processor comprising one or more processing units. The storage media may be integrated into and/or separate from the CPU 202. The code is configured so as when fetched from the memory and executed on the processor to perform operations in line with embodiments discussed herein. Alternatively, it is not excluded that some or all of the functionality of the CPU 202 is implemented in dedicated hardware circuitry (e.g. ASIC(s), simple circuits, gates, logic, and/or configurable hardware circuitry like an FPGA). In other embodiments (not shown) a processing system executes the processing steps described herein, wherein the processing system may consist of the processor as described herein or may be comprised of distributed processing devices that may be distributed across two or more devices. Each processing device of the distributed processing devices may comprise any one or more of the processing devices or units referred to herein.

FIG. 2 shows the CPU 202 being connected to an active reflected wave detector 206. The CPU 202 may optionally also be connected to a camera 210 and/or one or more activity sensor 212. The activity sensor(s) 212 are each configured to detect activity in the environment. Such activity sensors do not identify what the activity is; they merely detect that there is activity without determining (i.e. identifying) the activity. In implementations that use multiple activity sensors, the multiple activity sensors may detect activity in different regions of the environment (e.g. different rooms of a home, or more preferably a different regions of the same room).

While in the illustrated embodiment the activity sensor(s) 212, active reflected wave detector 206, and the camera 210 are separate from the CPU 202, in other embodiments, at least part of processing aspects of the activity sensor(s) 212 and/or active reflected wave detector 206 and/or camera 210 may be provided by a processor that also provides the CPU 202, and resources of the processor may be shared to provide the functions of the CPU 202 and the processing aspects of the activity sensor(s) 212 and/or active reflected wave detector 206 and/or camera 210. Similarly, functions of the CPU 202, such as those described herein, may be performed in the activity sensor(s) 212 and/or the active reflected wave detector 206 and/or the camera 210.

As shown in FIG. 2, a housing 200 of the device 102 may house the activity sensor(s) 212, the active reflected wave detector 206, and the camera 210. Alternatively, the activity sensor(s) 212 may be external to the device 102 and be coupled to the CPU 202 by way of a wired or wireless connection. Similarly, the active reflected wave detector 206 may be external to the device 102 and be coupled to the CPU 202 by way of a wired or wireless connection. Similarly, the camera 210 may be external to the device 102 and be coupled to the CPU 202 by way of a wired or wireless connection. Further, the outputs of the activity sensor(s) 212 and/or active reflected wave detector 206 and/or camera 210 may be wirelessly received from/via an intermediary device that relays, manipulates and/or in part produces their outputs.

One example activity sensor 212 is a motion sensor. In implementations using a motion sensor 212, the CPU 202 is configured to detect motion in the environment based on an output of the motion sensor. The motion sensor may be a passive infrared (PIR) sensor. The motion sensor is preferably a PIR sensor, however it could be an active reflected wave sensor, for example radar, that detects motion based on the Doppler effect. For example, the motion sensor may be a radar based motion sensor which detects motion based on the Doppler component of a radar signal. The activity sensor(s) 212 may include a microphone, a vibration sensor, and/or an infrared sensor. Other types of activity sensors are known to persons skilled in the art.

In an activated state, the active reflected wave detector 206 operates to measure wave reflections from the environment.

The active reflected wave detector 206 may operate in accordance with one of various reflected wave technologies. In operation, the CPU 202 may use the output of the active reflected wave detector 206 to determine the presence of a target object (e.g. human).

The active reflected wave detector 206 is a ranging detector. That is, in contrast with Doppler-only detectors, the active reflected wave detector 206 is configured to determine the location of an object (e.g. a person) in its field of view. This enables the CPU 202 to track the location of an object in the environment and also to determine which detected object is nearest.

In some implementations, the active reflected wave detector 206 may provide both a ranging based output and a Doppler-based output based on measuring wave reflections from the environment. In these implementations, the active reflected wave detector 206 is configured to detect motion in a region in the environment, and a dedicated motion sensor 212 is not required.

Preferably, the active reflected wave detector 206 is a radar sensor. The radar sensor 206 may use millimeter wave (mmWave) sensing technology. As will be appreciated, embodiments may additionally or alternatively be based on microwaves and/or other radio frequencies. The radar is, in some embodiments, a continuous-wave radar, such as frequency modulated continuous wave (FMCW) technology. Such a chip with such technology may be, for example, Texas Instruments Inc. part number iwr6843AOP. The radar may operate in microwave frequencies, e.g. in some embodiments a carrier wave in the range of 1-100 GHz (76-81 Ghz or 57-64 GHz in some embodiments), and/or radio waves in the 300 MHz to 300 GHz range, and/or millimeter waves in the 30 GHz to 300 GHz range. In some embodiments, the radar has a bandwidth of at least 1 GHz. The active reflected wave detector 206 may comprise antennas for both emitting waves and for receiving reflections of the emitted waves, and in some embodiment different antennas may be used for the emitting compared with the receiving.

As will be appreciated the active reflected wave detector 206 is an “active” detector in the sense of it relying on delivery of waves from an integrated source in order to receive reflections of the waves. The active reflected wave detector 206 is not limited to being a radar sensor, and in other embodiments alternative ranging detectors may be used, for example the active reflected wave detector 206 may be a LIDAR sensor, or a sonar sensor.

The active reflected wave detector 206 being a radar sensor is advantageous over other reflected wave technologies in that radar signals may transmit through some materials, e.g. wood or plastic, but not others—notably water which is important because humans are mostly water. This means that the radar can potentially “see” a person in the environment even if they are behind an object of a radar-transmissive material. Depending on the material, this may not be the case for sonar or lidar.

In some embodiments, the CPU 202 is configured to control the camera 210 to capture an image (represented by image data) of the environment. The camera 210 is preferably a visible light camera in that it senses visible light. Alternatively, the camera 210 senses infrared light. One example of a camera which senses infrared light is a night vision camera which operates in the near infrared (e.g. wavelengths in the range 0.7-1.4 μm) which requires infrared illumination e.g. using infrared LED(s) which is not visible to an intruder. Another example of a camera which senses infrared light is a thermal imaging camera which is passive in that it does not require an illuminator, but rather, senses light in a wavelength range (e.g. a range comprising 7 to 15 μm, or 7 to 11 μm) that includes wavelengths corresponding to blackbody radiation from a living person (around 9.5 μm). The camera 210 may be capable of detecting both visible light and, for night vision, near infrared light. The CPU 202 may comprise an image processing module for processing image data captured by the camera 210.

The device 102 may comprise a communications interface 214 for communication of data to and from the device 102. For example, the device 102 may communicate with a remote device via the communications interface 214. This enables a fall detection alert message to be sent from the device 102 to a remote device (not shown in FIGS. 1 and 1b), which may be via a wireless connection. This remote device may for example be a mobile computing device (e.g. a tablet or smartphone) associated with a carer or relative. Alternatively the remote device may be a computing device in a remote location (e.g. a personal computer in a monitoring station). Alternatively the remote device may be a control hub in the environment 100 (e.g. a wall or table mounted control hub). The control hub may be a control hub of a system that may be monitoring system and/or may be a home automation system. The notification to the control hub is in some embodiments via wireless personal area network, e.g. a low-rate wireless personal area network.

Additionally or alternatively, the device 102 may communicate, via the communications interface 214, with one or more of the activity sensor(s) 212, the active reflected wave detector 206, and the camera 210 in embodiments in which such components are not housed in the housing 200 of the device 102.

The device 102 may comprise an output device 208 to output a fall detection alert or other message. For example, the CPU 202 may control a visual output device (e.g. a light or a display) on device 102 to output a visual alert of the fall detection. Alternatively or additionally, the CPU 202 may control an audible output device (e.g. a speaker) on device 102 to output an audible alert of the fall detection.

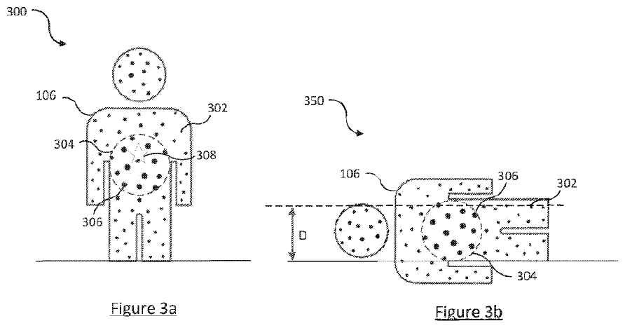

FIG. 3a illustrates a free-standing human body 106 with indications of reflective wave reflections therefrom in accordance with embodiments.

For each reflected wave measurement, for a specific time in a series of time-spaced reflective wave measurements, the reflective wave measurement may include a set of one or more measurement points that make up a “point cloud”. Each point 302 in the point cloud may be defined by a 3-dimensional spatial position from which a reflection was received, and defining a peak reflection value, and a doppler value from that spatial position. Thus, a measurement received from a reflective object may be defined by a single point, or a cluster of points from different positions on the object, depending on its size.

In some embodiments, such as in the examples described herein, the point cloud represents only reflections from moving points of reflection, for example based on reflections from a moving target. That is, the measurement points that make up the point cloud represent reflections from respective moving reflection points in the environment. This may be achieved for example by the active reflected wave detector 206 using moving target indication (MTI). Thus, in these embodiments there must be a moving object in order for there to be reflected wave measurements from the active reflected wave detector (i.e. measured wave reflection data), other than noise. The minimum velocity required for a point of reflection to be represented in the point cloud is less for lower frame rates. Alternatively, the CPU 202 receives a point cloud from the active reflected wave detector 206 for each frame, where the point cloud has not had pre-filtering out of reflections from moving points. Preferably for such embodiments, the CPU 202 filters the received point cloud to remove points having Doppler frequencies below a threshold to thereby obtain a point cloud representing reflections only from moving reflection points. In both of these implementations, the CPU 202 accrues measured wave reflection data which corresponds to point clouds for each frame whereby each point cloud represents reflections only from moving reflection points in the environment.

In other embodiments, no moving target indication (or any filtering) is used. In these implementations, the CPU 202 accrues measured wave reflection data which corresponds to point clouds for each frame whereby each point cloud can represent reflections from both static and moving reflection points in the environment. Even without removal of measurement points representing reflections from static objects the lower frame rate can still detect slower movements than at the higher frame rate.

FIG. 3a illustrates a map of reflections. The size of the point represents the intensity (magnitude) of energy level of the radar reflections (see larger point 306). Different parts or portions of the body reflect the emitted signal (e.g. radar) differently. For example, generally, reflections from areas of the torso 304 are stronger than reflections from the limbs. Each point represents coordinates within a bounding shape for each portion of the body. Each portion can be separately considered and have separate boundaries, e.g. the torso and the head may be designated as different portions. The point cloud can be used as the basis for a calculation of a reference parameter or set of parameters which can be stored instead of or in conjunction with the point cloud data for a reference object (human) for comparison with a parameter or set of parameters derived or calculated from a point cloud for radar detections from an object (human).

When a cluster of measurement points are received from an object in the environment 100, a location of a particular part/point on the object or a portion of the object, e.g. its centre, may be determined by the CPU 202 from the cluster of measurement point positions having regard to the intensity or magnitude of the reflections (e.g. a centre location comprising an average of the locations of the reflections weighted by their intensity or magnitude). As illustrated in FIG. 3a, the reference body has a point cloud from which its centre has been calculated and represented by the location 308, represented by the star shape. In this embodiment, the torso 304 of the body is separately identified from the body and the centre of that portion of the body is indicated. In alternative embodiments, the body can be treated as a whole or a centre can be determined for each of more than one body part e.g. the torso and the head, for separate comparisons with centres of corresponding portions of a scanned body.

In one or more embodiments, the object's centre or portion's centre is in some embodiments a weighted centre of the measurement points. The locations may be weighted according to an Radar Cross Section (RCS) estimate of each measurement point, where for each measurement point the RCS estimate may be calculated as a constant (which may be determined empirically for the reflected wave detector 206) multiplied by the signal to noise ratio for the measurement divided by R⁴, where R is the distance from the reflected wave detector 206 antenna configuration to the position corresponding to the measurement point. In other embodiments, the RCS may be calculated as a constant multiplied by the signal for the measurement divided by R⁴. This may be the case, for example, if the noise is constant or may be treated as though it were constant. Regardless, the received radar reflections in the exemplary embodiments described herein may be considered as an intensity value, such as an absolute value of the amplitude of a received radar signal.

In any case, the weighted centre, WC, of the measurement points for an object may be calculated for each dimension as:

$$WC = \frac{1}{{\sum }_{n = 1}^{N} {W}_{n}} {\sum }_{n = 1}^{N} ( {W}_{n} {P}_{n} )$$

Where:

N is the number of measurement points for the object;

Wₙ is the RCS estimate for the n^{th} measurement point; and

Pₙ is the location (e.g. its coordinate) for the n^{th} measurement point in that dimension.

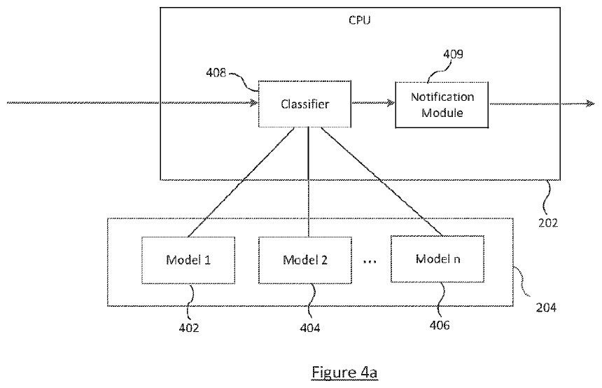

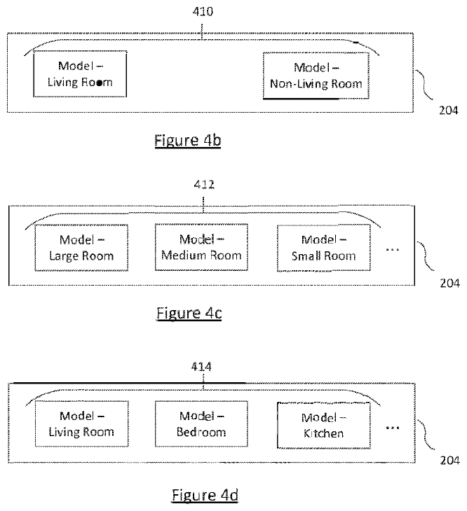

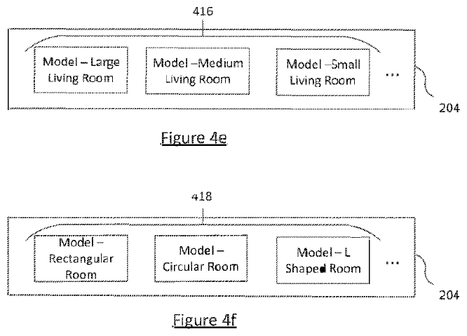

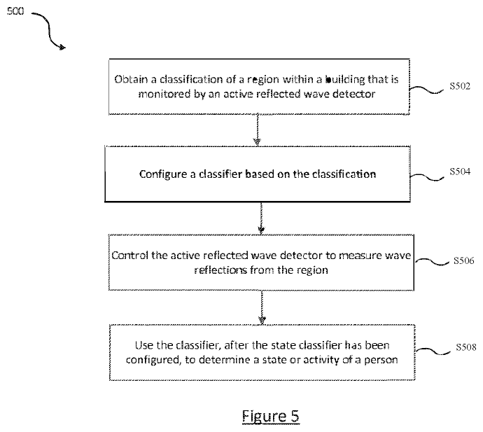

As shown in FIG. 4a, the CPU 202 comprises a classifier 408 and a notification module 409. The classifier 408 is configured to determine a state or activity of a person in the environment based on measured wave reflection data.

In operation, the active reflected wave detector 206 performs one or more reflected wave measurements at a given moment of time, and over time these reflected wave measurements can be correlated by the CPU 202 with a state of the person and/or an activity of the person.

In the context of the present disclosure, the state of the person determined by the classifier 408 may be a characterization of the person based on a momentary assessment (e.g. whether the person is in a fall state or a non-fall state). For example, a classification based on their position (e.g. in a location in respect to the floor and in a configuration which are consistent or inconsistent with having fallen) and/or their kinematics (e.g. whether they have a velocity that is consistent or inconsistent with them having fallen, or having fallen possibly being immobile). The state of the person may define whether the person is in a fall state or a non-fall state. In some embodiments, the classification performed by the classifier 408 may provide further detail on a non-fall state for example, the classifier 408 may be able to classify the person as being in a state from one or more of: a free-standing state (e.g. they are walking); a safe supported state which may be a reclined safe supported state whereby they are likely to be safely resting (e.g. a state in which they are in an elevated lying down position, or in some embodiments this may additionally encompass being in a sitting position on an item of furniture); and a standing safe supported state (e.g. they are standing and leaning on a wall). In other embodiments the non-fall states may be grouped differently. For example, the non-fall states may include a stationary non-floor position (encompassing both a reclined safe supported state and a standing stationary state whether supported or not in the standing state) and an ambulatory state. The classifier 408 may be able to classify the person as crawling, which may be regarded as a fall state or a non-fall state (given that if the person has fallen the person is still able to move so may be regarded as less critical) dependent on how the CPU 202 is configured.

The CPU 202 may be configured to determine the condition of a person in the environment using the output of the classifier 408. In the context of the present disclosure, the condition of the person determined by the CPU 202 may comprise a determination of an aspect of the person's health or physical predicament, for example whether they are in a fall condition whereby they have fallen and are substantially immobile, such that they may not be able (physically and/or emotionally) to get to a phone to call for help. That is, determining that a person is in a “fall condition” refers herein to determining that they have actually fallen.

The condition of the person may in some contexts be synonymous with the state of the person. For example, by determining that the person is in a standing state, it may be concluded by the CPU 202 that the person is not currently in a fall condition, whereby they are on the floor and potentially unable to seek help. It is possible to detect a fall based on a single detection of a fall state (e.g. that the person is in a position consistent with having fallen), but doing so has a relatively high risk of false alarms. Thus, the determination that a person is in a “fall condition” performed by the CPU 202 involves an assessment of the person's fall status over time, such as in the order of 30-60 seconds, whereby multiple time separated determinations of the person having a fall status is needed in order to conclude there is a fall condition. For example, a person may be classified as being in a fall state by the classifier 408 and then after a predetermined amount of time the fall status of the person is then reclassified by the classifier 408 to see if the person is still in the same position, and if so, the CPU 202 determines that there is a person in a fall condition (because they have been in a fall position for some amount of time deemed to indicate they may need help). Power can be advantageously conserved energy by switching the active reflected wave detector 206 to a lower power state (e.g. off or asleep) between the reflected wave measurements performed by the active reflected wave detector 206.

In the context of the present disclosure, an activity of a person may refer to what action the person is involved in (e.g. what they are engaged in or what they are doing) over time. Examples include watching TV, eating, conversing, walking and playing an instrument. It will be appreciated that some activities (e.g. walking) could be equally categorized as being states.

In order to classify the state or activity of a person the classifier 408 processes the measured wave reflections by determining one or more parameters associated with the measured wave reflections and then supplies the determined parameters as inputs into a trained classifier model to classify the state of a person.

The person may be tracked using a tracking module of the classifier 408. The tracking module can use any known tracking algorithm. For example, the active reflected wave detector 206 may generate a plurality of detection measurements (e.g. up to 100 measurements, or in other embodiments hundreds of measurements) for a given frame. Each measurement can be taken a defined time interval apart such as 0.5, 1, 2 or 5 seconds apart. Each detection measurement may include a plurality of parameters in response to a received reflective wave signal above a given threshold. The parameters for each measurement may for example include an x and y coordinate (and z coordinate for a 3D active reflected wave detector 206), a peak reflection value, and a doppler value corresponding to the source of the received radar signal.

The data can then be processed using a clustering algorithm to group the measurements into one or more measurement clusters corresponding to a respective one or more targets. An association block may then associate a given cluster with a given previously measured target. A Kalman filter of the tracking module may then be used to determine the next position of the target based on the corresponding cluster of measurements and the prediction of the next position based on the previous position and other information e.g. the previous velocity.

From the reflected wave measurements an RCS of an object represented by a cluster of measurement points can be estimated by summing the RCS estimates of the each of the measurement points in the cluster. This RCS estimate may be used to classify the target as a human target if the RCS is within a particular range potentially relevant to humans for the frequency of the signal emitted by the active reflected wave detector 206, as the RCS of a target is frequency dependent. Taking a 77 GHz radar signal as an example, from empirical measurements, the RCS (which is frequency dependent) of an average human may be taken to be in the order of 0.5 m², or more specifically in a range between 0.1 and 0.7 m², with the value in this range for a specific person depending on the person and their orientation with respect to the radar. The RCS of human in the 57-64 GHz spectrum is similar to the 77 GHz RCS—i.e. 0.1 and 0.7 m².

The tracking module may output values of location, velocity and/or RCS for each target, and in some embodiments also outputs acceleration and a measure of a quality of the target measurement, the latter of which is essentially to act as a noise filter. The values of position (location) and velocity (and acceleration, if used) may be provided in 2 or 3 dimensions (e.g. cartesian or polar dimensions), depending on the embodiment.

The Kalman filter tracks a target object between frames and therefore multiple frames of reflection measurement data can be used to determine a person's velocity. Three or more frames (e.g. 3-5 frames) may be required in order to determine that there is movement exceeding a movement threshold. The frames may be taken at a rate of 2 Hz, for example. In order to classify the state of the person in the environment, the classifier 408 may determine a height metric associated with at least one measurement of a reflection from the person conveyed in the output of the active reflected wave detector 206 and compare the height metric to at least one threshold.

The height metric may be a height of a weighted centre of the measurement points of a body or part thereof (where each measurement is weighted by the RCS estimation).

The height metric used to classify the state or activity of the person is not limited to being a height of a weighted centre of the measurement points of the person's body or part thereof. In another example, the height metric may be a maximum height of all of the height measurements associated with the person's body or part thereof. In another example, the height metric may be an average height (e.g. median z value) of all of the height measurements of the person's body or part thereof. In the case of using a weighted centre or average height, the “part thereof” may beneficially be a part of the body that is above the person's legs to more confidently distinguish between fall and non-fall positions.

In order to classify the state of the person in the environment, the classifier 408 may determine a velocity associated with the person using the measurements of reflections that are conveyed in the output of the active reflected wave detector 206 and compare the velocity to a velocity threshold. The tracking module referred to above may output a value of velocity for the target (person in the environment). For example, the velocity may assist in classifying whether a human is present in the environment. For example, it may be concluded that no human is present if there is no detected object having a velocity within a predefined range and or having certain dynamic qualities that are characteristic of a human. The comparison between the detected velocity associated with the person and the velocity threshold can also assist with narrowing the classification down to a specific state. For example if the detected velocity associated with the person is not greater than the velocity threshold the classifier 408 may determine that the person is not moving and, if sitting or lying on the floor, is in a fall state.

In order to classify the state or activity of the person in the environment, the classifier 408 may determine a spatial distribution, e.g. a variance or standard deviation, of the measurements of reflections that are conveyed in the output of the active reflected wave detector 206. This may include determining a horizontal spatial distribution of the measurements of reflections that are conveyed in the output of the active reflected wave detector 206. Alternatively or additionally, this may include determining a vertical spatial distribution of the measurements of reflections that are conveyed in the output of the active reflected wave detector 206.

One or more parameters associated with the measured wave reflections are supplied as the input (i.e. the input layer) into a trained classifier model.

The parameters are preferably extracted features from the measured wave reflections. This enables models consuming significantly less memory than models trained on the wave reflection data itself (e.g. the point cloud). Thus, to save memory, the model input may comprise extracted features and not the measured wave reflections. The extracted features may include one or more of: (i) a height metric associated with at least one reflection; (ii) a velocity associated with the person using the measurements of reflections; and (iii) a spatial distribution characterization of the measurements (e.g. one or more of a horizontal spatial distribution (e.g. a variance or equivalently a standard deviation), a vertical spatial distribution and a ratio therebetween. Additionally, RCS estimates may be used to aid in assessing whether the object being classified is in fact a human. Analysis of the wave reflections to determine whether the object is likely to be human may be performed before or after the classification, but in other embodiments it may be performed as part of the classification. Thus, the classifier may additionally receive the following parameters: (iv) a sum of RCS estimates, and in some embodiments (v) a distribution (e.g., variance or equivalently standard deviation) of RCS estimates. For example, the received parameters may be: 1. an average height (e.g. median z value); 2. a standard deviation of RCS estimates; 3. A sum of RCS estimates; and 4. a standard deviation of height(z) values.

As shown in FIG. 4a, the classifier 408 has access to a plurality of trained classifier models which are shown in FIG. 4a as models 402, 404 and 406.

As shown in FIG. 4a, one or more of the plurality of trained classifier models may be stored in memory 204 of the device 102. One or more of the plurality of trained classifier models may be stored on a remote device (e.g. a remote sever), and the device 102 is able to retrieve models that are stored on the remote device via the communications interface 214.

Each of the plurality of trained classifier models are classified according to at least one classification (e.g. size, functional design, and/or geometry) of a region of a building to which it relates. In particular, a trained classifier model that is classified according to a particular classification is trained with wave reflection data training sets each associated with the particular classification.

A region of a building may correspond to an enclosed space of a building. An enclosed space of building may be a room of a building, which may have a functional design that is for example a kitchen, a bedroom, a bathroom, a dining room, a living room/lounge, a study, a utility room, a toilet, etc.

A region of a building may correspond to a circulation space of the building which is predominately used for circulation of people, which may have a functional design of being, for example, a hallway, corridor, stairs, a landing, etc. A circulation space (e.g. a corridor or hallway) may also be an enclosed space.

For state detection, each of the plurality of trained classifier models are trained with wave reflection data training sets associated with a person in different states when in a region of a building, with each wave reflection data training set comprising wave reflection data of a person in particular state of the different states.

For activity detection, each of the plurality of trained classifier models are trained with wave reflection data training sets associated with a person performing different activities when in a region of a building, with each wave reflection data training set comprising wave reflection data of a person performing a particular activity of the different activities.

As used herein, “determining a state or activity” may comprise identifying only a state, only an activity or both a state and an activity. An example of identifying both a state and an activity may be that a person is respectively both sitting and, at the same time, eating. A particular classifier model of the plurality of trained classifier models may be trained with multiple wave reflection data training sets associated with a person. The person may be in the same region of a particular building (e.g. at different locations in the same region) or in different regions of different buildings, each of the different regions having the same classification. Thus taking the example of a classifier model relating to a bedroom, a classifier model may be trained with wave reflection data training sets associated with a person in one or more bedrooms. However, in any case, preferably a plurality of different bedrooms are used to train the classifier model corresponding to a bedroom. The person may be the same person, or different people may be used in the creation of the wave reflection data training sets.

For state identification, a particular classifier model of the plurality of trained classifier models may be trained with wave reflection data training sets associated with a person in multiple different states. In order for a classifier based on a particular classifier model to identify whether someone is in particular state, the classifier model may be trained with at least one wave reflection data training set associated with a person in the particular state, and at least one wave reflection data training set associated with a person that is in a state that is not the particular state. Taking the example of a classifier model relating to bedroom, each of the wave reflection data training sets used to train the classifier model is associated with a person in a bedroom in a respective one of multiple different states that are opposite to one another. For example, a classifier model may be trained with at least a first wave reflection data training set associated with a person in a bedroom in a fall state, and at least a second wave reflection data training set associated with a person in a bedroom in a non-fall state.

Optionally a plurality of sub-states may correspond to a given state. For example, training data corresponding to a fall state may include training data for which the person is sitting on the floor and training data for which a person is lying on the floor. For example, if the person is determined to be in either sitting on the floor or lying on the floor it may be determined that the person is a position consistent with having fallen, and thus in a fall state. In an embodiment, one model may be trained to differentiate between the different substates. In another embodiment, different models may respectively be used to identify whether or not the person is in the different substates, e.g. a model trained for identifying whether or not the person is sitting on the floor and a model trained for identifying whether or not the person is lying on the floor. Alternatively training data may be used which does not differentiate between sitting on the floor and lying on the floor, whereby the classifier does not identify the sub-states.

For activity identification, a particular classifier model of the plurality of trained classifier models may be trained with wave reflection data training sets associated with a person performing multiple different activities. However, regardless of whether training the model in respect of one activity or multiple different activities, in order for a classifier based on a particular classifier model to identify whether someone is performing a particular activity, the classifier model may be trained with at least one wave reflection data training set associated with a person performing the particular activity, and at least one wave reflection data training set associated with a person that is not performing the particular activity.

Each of the plurality of trained classifier models may consume no more than 500 kB of memory, preferably less than 100 kB of memory, more preferably less than 50 kB (e.g. 40-50 kB). It will be appreciated that when each of the plurality of trained classifier models consume no more than 500 kB of memory this excludes the use of Bagged Tree models, which tend to consume 1 MB or more.

Each of the plurality of trained classifier models may be a decision tree or a support vector machine (SVM) model.

Each of the plurality of trained classifier models may be a deep learning model comprising a neural network having an input layer, an output layer and at least one condensed layer (i.e. hidden layer) between the input layer and the output layer. Preferably there is no more than 4 condensed layers (i.e. hidden layers) between the input layer and the output layer. Each condensed layer may consist of no more than 64 neurons or more preferably no more than 32 neurons.

FIGS. 4b-4f illustrates how each of the plurality of trained classifier models may be classified according to one or a plurality of classifications (e.g. size, functional design, and/or geometry) of a region of a building to which it relates.

FIG. 4b illustrates how the plurality of trained classifier models may comprise only two classifier models 410 that have been classified according to the functional design of a region of a building used to collect the wave reflection data training sets used to train the classifier models 410. The functional design of a region may define what a room, or space within a room, is designed for, such as the examples of enclosed spaces and circulation spaces provided above (e.g. design to be used as a living room, a corridor, etc.). As shown in FIG. 4b the two classifier models 410 include a classifier model for determining a particular state or activity for a living room, and a classifier model for determining a particular state or activity for any rooms that are not a living room. The living room classification may correspond to a room size that is greater than a room size corresponding to the non living-room classification.

FIG. 4c illustrates how the plurality of trained classifier models may comprise classifier models 412 that have been classified according to the size of a region of a building used to collect the wave reflection data training sets used to train the classifier models 412. As an example to illustrate the concept, FIG. 4c shows a classifier model for determining a particular state or activity for a large room, a classifier model for determining a particular state or activity for a medium size room, and a classifier model for determining a particular state or activity for a small room. It will be appreciated that each of the classifier models 412 may cover a range of different sized regions.

The size of a region associated with the classifier models 412 may be defined by a maximum horizontal distance from the active reflected wave detector 206 to a furthest boundary (e.g. wall) of the region, or to a further distance at which a person at the boundary could be located. Appropriate limits of a given size classification may be determined empirically by testing classification performance (e.g. classification accuracy) according to those limits and selecting the size limits to optimize performance. Consider an example whereby the classifier models 412 comprises only two models: a classifier model for determining a particular state or activity for a large room, and a classifier model for determining a particular state or activity for a small room. In an example, regions in which the maximum horizontal distance from the active reflected wave detector 206 to the distance at which a person could be located is greater than or equal to 4.1 m may be considered a large room, and regions in which the maximum distance from the active reflected wave detector 206 to the distance at which a person could be located is less than 4.1 m may be considered a small room. The threshold distance may have a value of between 4 m and 4.2 m. Other threshold distance values may also be used.

The size of a region associated with the classifier models 412 may be defined by an area or range of areas, in metres squared. Alternatively or additionally, the size of a region associated with the classifier models 412 may be defined by a volume or range of range of volumes, in cubic metres. It will be appreciated that the classifier models 412 may be classified according to size in a different manner than that shown in FIG. 4c.

FIG. 4d illustrates how the plurality of trained classifier models may comprise classifier models 414 that have been classified according to the functional design of a region of a building used to collect the wave reflection data training sets used to train the classifier models 414. The functional design of a region may define what a room, or space within a room, is designed for. In particular, the classifier models 414 comprise a classifier model for determining a particular state or activity for a living room, a classifier model for determining a particular state or activity for a bedroom, and a classifier model for determining a particular state or activity for a kitchen. Thus in contrast to FIG. 4b, there are dedicated classifier models for determining a particular state or activity in different types of non-living rooms. The functional design of a region may define how a room has been set up to be used, given that some rooms may be reasonably used for set up for different purposes, e.g. a given room may be selectively furnished for use as a bedroom or an office a variety of different. Thus, the classifier models 414 may additionally or alternatively comprise models classified according to how a room, used to collect the wave reflection data training sets, is set up to be used, as opposed to just structural architectural features of the room.

The plurality of trained classifier models may comprise models that have been classified according to a combination of classifications (e.g. size, functional design, geometry) of a region of a building to which it relates. FIG. 4e illustrates an example of this whereby the plurality of trained classifier models comprise classifier models 416 associated with different size classifications of regions of a building, the different size classifications being for the same functional design. As an example to illustrate the concept, FIG. 4e shows a classifier model for determining a state or activity for a large living room, a classifier model for determining a state or activity for a medium size living room, and a classifier model for determining a state or activity for a small living room. It will be appreciated that each of the classifier models 416 may cover a respective range of different sized regions.

FIG. 4f illustrates how the plurality of trained classifier models may comprise classifier models 418 that have been classified according to the geometry of a region of a building used to collect the wave reflection data training sets used to train the classifier models 418. As an example to illustrate the concept, FIG. 4f shows a classifier model for determining a state or activity for a rectangular room, a classifier model for determining a state or activity for a circular room, and a classifier model for determining a state or activity for an L-shaped room. Further the different geometry classifications may also be defined according to where the active reflected wave detector is located with respect to the geometry. For example, in a corner of a room or in the middle of a side wall of a room or, for an L-shaped room, where with respect to the L-shape.

We now refer to FIG. 5 which illustrates a process 500 performed by the CPU 202 to determine a state or activity of a person in accordance with embodiments of the present disclosure.

The active reflected wave detector 206 is configured to monitor a region within a building. In particular, the active reflected wave detector 206 operates to measure wave reflections from the region. The region is dependent on an installation location of the active reflected wave detector 206, or the device 102 (in embodiments in which the active reflected wave detector is housed within the device 102), within the building selected by an installer. The region of the building may be an enclosed space of the building e.g. a kitchen, a bedroom, etc., or the region of the building may be within an enclosed space of the building e.g. a sleeping area of a studio apartment.

The region of the building may be a circulation space of the building e.g. stair, hallway etc., or the region of the building may be within a circulation space of the building. At step S502 the CPU 202 obtains a classification of the region within the building that is monitored by the active reflected wave detector 206. The classification of the region may comprise one or more of a size classification of the region, a functional design classification of the region, and a geometric classification of the region. The CPU 202 obtains the classification of the region by retrieving it from memory 204 coupled to the CPU 202. It will be appreciated that the classification of the region may be stored in transient (temporary) memory of the device 102, or stored in non-transient (permanent) memory of the device 102.

At step S504 the CPU 202 configures the classifier 408 based on the classification of the region obtained at step S502. In particular, the CPU 202 selects a classifier model that corresponds to the classification of the region obtained at step S502, accesses the selected classifier model (e.g. by retrieving it from local memory 204 or downloading it from a remote device via the communications interface 214), e.g. by loading it into Random Access Memory and configures the classifier 408 such that it will use the selected classifier model for future determinations of the state or activity of a person. At step S506, the CPU 202 controls the active reflected wave detector 206 to measure wave reflections from the region within the building to receive measured wave reflection data that is obtained by the active reflected wave detector 206.

At step S508, the CPU 202 uses the classifier 408, after it has been configured at step S504, to determine the state or activity of the person using the measured wave reflection data.

The CPU 202 is configured to process measured wave reflections from the environment that are measured by the active reflected wave detector 206 to detect whether a person is in the environment and, if a person is detected, classify a state or activity of the person in the environment. This need not be a two-step process i.e. of looking for a person and then classifying them. For example, the CPU 202 may take the output of the active reflected wave detector 206 and do a classification, wherein one of the outputs of the classification is that there is no person, or in other embodiments it may only conclude that there is no person if it fails to perform a classification of a person's state or activity. When classifying the state of a person, the CPU 202 may perform a determination that the person is in a fall state (i.e. a position that is consistent with them haven fallen) or a non-fall state (indicative that they are, at least temporarily, in a safe state). In embodiments of the present disclosure the determination that the person is in a fall position is used as an indicator that the person may be in need of help. Being in a position which is consistent with the person having fallen does not necessarily mean they have fallen, or have fallen such that they need help. For example, they may be on the floor for other reasons, or they may have had a minor fall from which they can quickly recover. However, if they remain in a fall position for sufficient time it may be concluded that they are sufficiently likely to have fallen to be classified as being in a fall condition, and the device 102 may therefore take appropriate action accordingly, e.g. by sending a notification to a remote device via the notification module 409.

The state or activity classification may be performed by the CPU 202 by looking at a set of sequential frames over a period of time. For example, for state classification, the CPU 202 may classify the state of the person as being in a fall position based on the person's fall/non-fall positions for the respective frames. Multiple frames (e.g. 10 frames) may be used to determine whether there are more fall or non-fall results to improve the accuracy of the determination (e.g. the result which occurs more is the selected result).

At step S508, the configured classifier model uses the received parameters and the training data set(s) associated with the configured classifier model to classify the state or activity of the person in the environment. It will be appreciated that this can be implemented in various ways.

The trained classifier model may be used at operation time to determine a classification score, using a method known by the person skilled in the art. The score may for example provide an indication of a likelihood or level of confidence that the received parameters correspond to a particular state or activity of a person.

A determination of a particular classification (e.g. a particular state or activity of the person) may for example be based on whether a classification confidence score is greater than a threshold, then the person is determined to be in that state or activity. For example, the CPU 202 may determine that the person is in a fall state if the output of the classifier determines that there is more than a 60% likelihood (or some other predefined likelihood threshold, which may optionally be greater than 50%, or even less than 50% to be conservative/cautious) of the person being in a fall position. However, in some embodiments to ameliorate the risk of a false positive fall detection, the threshold confidence for determine that the person is in a fall state is in the range of 85-90%, e.g. 88%. In other words, if there is a confidence of being in a fall state that is greater than the threshold confidence it may concluded that the person is in a fall state. Likewise, if there is a confidence of being in a fall state that is less than the threshold confidence (88% in this example) then it may be concluded that the person is in a non-fall state.

Furthermore, as noted above, there need not be a two-step process of looking for a person and then classifying them. A trained classifier model could be used that is trained of different data that is not necessarily limited to reflections from discreet objects or from objects already identified as potentially being human. For example, a classifier could be fed respective sets of training data for (i) a person is present and in a fall position; (ii) a person is present and in a non-fall position; and (iii) no person is present. The classifier may determine a classification of active reflective wave measurements based on which of the trained states it is most closely correlated with.

Any other method, known by the person skilled in the art, of training and using the classifier based on (i) the received parameters as exemplified above, and (i) the relevant output states may alternatively be used.

Regardless of how the classifier 408 classifies the state or activity of a person, the notification module 409 may be configured to output an indication of the determined state or activity. The notification module 409 may output the indication via the output device 208 (e.g. a visual and/or audible notification). Alternatively or additionally, the notification module 409 may output the indication to a remote device via the communications interface 214. For example, if the CPU 202 detects that a person in the environment has fallen, the notification module 409 may output a fall detection alert.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In addition, any priority document(s) of this application is/are hereby incorporated herein by reference in its/their entirety.

1. A computer implemented fall detection method for determining whether a person is in a fall state, the method comprising:
obtaining a classification of a region within a building that is monitored by an active reflected wave detector;
configuring a classifier based on the classification;
controlling the active reflected wave detector to measure wave reflections from the region within the building to receive measured wave reflection data that is obtained by the active reflected wave detector; and
using the classifier, after said configuring, to determine whether a person is in a fall state using the measured wave reflection data.

2. The computer implemented method of claim 1, wherein the region that is monitored by the active reflected wave detector is, or is within, an enclosed space of the building.

3-4. (canceled)

5. The computer implemented method of claim 1, wherein the classification of the region comprises a size classification of the region.

6. The computer implemented method of claim 1, wherein the classification of the region comprises a functional design classification of the region.

7. The computer implemented method of claim 1, wherein the classification of the region comprises a geometric classification of the region.

8. The computer implemented method of claim 1, wherein a plurality of trained classifier models are accessible to the classifier, the configuring the classifier comprises selecting a trained classifier model of the plurality of trained classifier models, and the selected trained classifier model is used to determine whether the person is in a fall state.

9. The computer implemented method of claim 8, the method further comprising:
determining one or more parameters associated with the measured wave reflection data; and
supplying the determined parameters as inputs into the selected trained classifier model to determine whether the person is in a fall state.

10. The computer implemented method of claim 9, wherein the determined parameters comprise features extracted from the measured wave reflection data and do not comprise the wave reflection data itself.

11.-12. (canceled)

13. The computer implemented method of claim 8, wherein the classifier models are stored on non-transient memory of a device, wherein the device comprises the active reflected wave detector.

14. The computer implemented method of claim 13, wherein storage of each classifier model respectively consumes no more than 500 kilobytes of memory.

15. The computer implemented method of claim 8, wherein the models are deep learning models.

16. The computer implemented method of claim 15, wherein each classifier model comprises an input and output and no more than 4 condensed layers.

17. The computer implemented method of claim 16, wherein each condensed layer consists of no more than 64 neurons.

18. The computer implemented method of claim 1, wherein the classification is selected from a group comprising:
a living room; and
a non living-room.

19. The computer implemented method of claim 18, wherein each classification in the group corresponds to a respective room size, wherein the living room classification corresponds to a room size that is greater than a room size corresponding to the non living-room classification.

20. At least one non-transitory computer-readable storage medium comprising instructions which, when executed by at least one processor cause the at least one processor to perform the method of claim 1.

21. A device for determining whether a person is in a fall state, the device comprising:
a processor, wherein the processor is configured to:
obtain a classification of a region within a building that is monitored by an active reflected wave detector;
configure a classifier based on the classification;
control the active reflected wave detector to measure wave reflections from the region within the building to receive measured wave reflection data that is obtained by the active reflected wave detector; and
use the configured classifier, to determine whether a person is in a fall state using the measured wave reflection data.

22. (canceled)

23. The device of claim 21, wherein the device further comprises the active reflected wave detector.

24. The device of claim 21, wherein the active reflected wave detector is a radar sensor.

25. A system for determining whether a person is in a fall state, the system comprising:
a processing system configured to perform the following steps:
obtain a classification of a region within a building that is monitored by an active reflected wave detector;
configure a classifier based on the classification;
control the active reflected wave detector to measure wave reflections from the region within the building to receive measured wave reflection data that is obtained by the active reflected wave detector; and
use the configured classifier, to determine whether a person is in a fall state using the measured wave reflection data.
